(19) United States
(12) Patent Application Publication
(10) Pub. No.: US 2014/0017499 A1
(43) Pub. Date: Jan. 16, 2014

(54) GLASS FOR CHEMICAL STRENGTHENING AND CHEMICAL STRENGTHENED GLASS

(71) Applicant: ASAHI GLASS COMPANY, LIMITED, Chiyoda-ku (JP)

(72) Inventor: Hiroyuki YAMAMOTO, Haibara-gun (JP)

(21) Appl. No.: 13/938,822

(22) Filed: Jul. 10, 2013

(30) Foreign Application Priority Data
Jul. 11, 2012 (JP) 2012-155566
Apr. 24, 2013 (JP) 2013-090940

(51) Int. Cl. C03C 3/11; C03C 3/085; C03C 3/087; C03C 21/00

(52) U.S. Cl. CPC C03C 3/11; C03C 21/002; C03C 3/085; C03C 3/087
USPC 428/410; 501/56; 501/69; 501/71

(57) ABSTRACT

Glass for chemical strengthening, comprising 0.001% to 5% of Se in terms of molar percentage as a coloring component in the glass, wherein the glass has a property configured to provide an absolute value of Δa*m with 1.8 or less, the absolute value of Δa*m being a difference Δa*m between a value of chromaticity a* of reflected light by a D65 light source and a value of chromaticity a* of reflected light by an F2 light source, in a L*a*b* color system, the difference being expressed by the following expression (1),

Δa*m=a*value(D65 light source)−a*value(F2 light source) (1).

### CROSS REFERENCE TO RELATED APPLICATIONS

This application is based upon and claims the benefit of priority from the prior Japanese Patent Application No. 2012-155566 filed on Jul. 11, 2012 and the prior Japanese Patent Application No. 2013-090940 filed on Apr. 24, 2013; the entire contents of which are incorporated herein by reference.

### FIELD

Embodiments described herein relate generally to glass for chemical strengthening and chemical strengthened glass used for exterior members and decorations of electronic devices such as, for example, communication devices and information devices portably usable. In this specification, “glass for chemical strengthening” refers to glass on whose surface a compressive stress layer can be formed by chemical strengthening and to glass before undergoing the chemical strengthening. Further, “chemical strengthened glass” refers to glass having undergone the chemical strengthening and having a compressive stress layer formed on its surface by the chemical strengthening.

### BACKGROUND

For exterior members and decorations of electronic devices such as cellular phones, an appropriate material selected from materials such as resin and metal is used in consideration of various factors such as decorativeness, scratch resistance, workability, and cost.

In recent years, attempts have been made to use, as a material of the exterior members, glass that has not been conventionally used. It has been known that, in an electronic device such as a cellular phone, an exterior member, when itself formed of glass, can exhibit a unique decorative effect having a transparent feeling.

Exterior members and decorations of portably usable electronic devices such as cellular phones are required to have high strength in consideration of breakage caused by a drop impact when in use and a contact scratch due to a long-term use.

As a method to increase strength of glass, a method of forming a compressive stress layer on a glass surface has been generally known. As the method of forming the compressive stress layer on the glass surface, an air-cooling tempering method (physical tempering method) and a chemical strengthening method are typical. The air-cooling tempering method (physical tempering method) is a method in which a surface of a glass plate heated nearly to a softening point is rapidly cooled by air cooling or the like. Further, the chemical strengthening method is a method in which alkali metal ions with a small ion radius present on a surface of a glass plate (typically, Li ions, Na ions) are exchanged with alkali ions having a larger ion radius (typically, Na ions or K ions for the Li ions, and K ions for the Na ions) by ion exchange at a temperature equal to a glass transition point or lower.

For example, in general, the glass for decoration as previously described is often used with a 2 mm thickness or less. When the air-cooling tempering method is employed for a glass plate having such a small thickness, it is difficult to ensure a temperature difference between the surface and the inside, which makes it difficult to form the compressive stress layer. Accordingly, it is not possible to obtain high strength being an aimed property in glass having undergone the strengthening. Further, the air-cooling tempering involves a great concern that planarity of the glass plate is impaired due to variation of cooling temperature. Especially a glass plate having a small thickness involves a great concern that its planarity is impaired, and there is a possibility that texture aimed by the present invention is impaired. From these points of view, the glass plate is preferably strengthened by the latter chemical strengthening method.

Further, as exterior members and decorations of electronic devices such as cellular phones, those having a dark color tone such as black and gray that do not make the presence of the device itself strongly felt and can produce a dignified feeling and a luxurious feeling are in heavy usage. Among them, a gray-based color tone gives a soft impression and makes stains due to extraneous matters on the surface less noticeable, and thus is in wide use in exterior members and the like of electronic devices.

As glass that can be chemical strengthened and presents a dark color, it has been known that the glass is aluminosilicate glass containing high-concentration iron oxide.

### DETAILED DESCRIPTION

For the use as exterior members and decorations of electronic devices, color is regarded as important as an outer quality. Since the well-known glass is what is called black, it completely shuts off lights having wavelengths in the visible range. However, the gray-based color tone as described above does not completely shut off the lights having the wavelengths in the visible range and transmits a certain amount of the lights having the wavelengths in the visible range, which necessitates color management in manufacturing processes. Electronic devices of a portable type are used under lights with different wavelength components, such as being used outdoors and indoors. Therefore, it is preferable that a variation amount of a color tone due to a difference in a light source, that is, so-called metamerism, is small.

Further, electronic devices are required to reflect diversified tastes of consumers and have various design expressions. A color tone among the design expressions is one of especially important factors. The aforesaid glass used for exterior members of electronic devices is required to faithfully reproduce a color tone based on data obtained in marketing activities and a color tone decided by a designer. However, the present inventor has found a new problem that a color tone of glass changes before and after the chemical strengthening depending on a coloring component in the glass.

It is an object of the embodiments of the present invention to provide glass for chemical strengthening and chemical strengthened glass that have properties suitable for use as exterior members and decorations of electronic devices, that is, that have suppressed metamerism, undergo only a small color tone change before and after chemical strengthening, are excellent in mechanical strength, and have a gray-based color tone.

As a result of various studies, the present inventor has found out that, in glass containing a certain amount of Se (selenium) as a coloring component, a color tone change (metamerism) of reflected light when light sources are different and a color tone change of the glass before and after chemical strengthening can be suppressed. Specifically, the glass for chemical strengthening of this embodiment contains 0.001% to 5% of Se in terms of molar percentage as a coloring component in the glass, wherein the glass has a property configured to provide an absolute value of Δa*m with 1.8 or less, the absolute value of Δa*m being a difference Δa*m between a value of chromaticity a* of reflected light by a D65 light source and a value of chromaticity a* of reflected light by an F2 light source, in a L*a*b* color system, the difference is expressed by the following expression (1).

Δa*m=a*value(D65 light source)−a*value(F2 light source) (1)

Specifically, the glass for chemical strengthening of this embodiment contains 0.05% to 5% of Se in terms of molar percentage as a coloring component in the glass, wherein the glass has a property configured to provide an absolute value of Δa*m with 1.8 or less, the absolute value of Δa*m being a difference Δa*m between a value of chromaticity a* of reflected light by a D65 light source and a value of chromaticity a* of reflected light by an F2 light source, in a L*a*b* color system, the difference being expressed by the following expression (1).

Δa*m=a*value(D65 light source)−a*value(F2 light source) (1)

Further, the glass for chemical strengthening of this embodiment contains 0.001% to 5% of Se in terms of molar percentage as a coloring component in the glass, wherein the glass has a property configured to provide an absolute value of Δa*m with 1.8 or less, the absolute value of Δa*m being a difference Δa*m between a value of chromaticity a* of reflected light by a D65 light source and a value of chromaticity a* of reflected light by an F2 light source, in a L*a*b* color system, the difference is expressed by the following expression (1), and an absolute value of Δb*m with 1.8 or less, the absolute value of Δb*m being a difference Δb*m between a value of chromaticity b* of the reflected light by the D65 light source and a value of chromaticity b* of the reflected light by the F2 light source, in the L*a*b* color system, the difference being expressed by the following expression (2).

Δa*m=a*value(D65 light source)−a*value(F2 light source) (1)

Δb*m=b*value(D65 light source)−b*value(F2 light source) (2)

Further, the glass for chemical strengthening of this embodiment contains 0.05% to 5% of Se in terms of molar percentage as a coloring component in the glass, wherein the glass has a property configured to provide an absolute value of Δa*m with 1.8 or less, the absolute value of Δa*m being a difference Δa*m between a value of chromaticity a* of reflected light by a D65 light source and a value of chromaticity a* of reflected light by an F2 light source, in a L*a*b* color system, the difference being expressed by the following expression (1), and an absolute value of Δb*m with 1.8 or less, the absolute value of Δb*m being a difference Δb*m between a value of chromaticity b* of the reflected light by the D65 light source and a value of chromaticity b* of the reflected light by the F2 light source, in the L*a*b* color system, the difference being expressed by the following expression (2).

Δa*m=a*value(D65 light source)−a*value(F2 light source) (1)

Δb*m=b*value(D65 light source)−b*value(F2 light source) (2)

Further, when the glass for chemical strengthening, after being chemically strengthened, is cooled in a temperature range from a chemical strengthening temperature to 300° C. at a cooling rate of 30° C./minute or more, the glass has a property configured to provide a color tone variation amount expressed by the following expression (5) with 1.0 or less,

\sqrt{(Δa*i)²+(Δb*i)²} Λ (5),

where Δa*i is a difference between a value of chromaticity a* of reflected light by the F2 light source before the chemical strengthening and a value of chromaticity a* of the reflected light by the F2 light source after the chemical strengthening and the cooling, in the L*a*b* color system, which difference is expressed by the following expression (3), and Δb*i is a difference between a value of chromaticity b* of the reflected light by the F2 light source before the chemical strengthening and a value of chromaticity b* of the reflected light by the F2 light source after the chemical strengthening and the cooling, in the L*a*b* color system, which difference is expressed by the following expression (4).

Δa*i=a*value (before chemical strengthening)−a*value (after chemical strengthening) (3)

Δb*i=b*value (before chemical strengthening)−b*value (after chemical strengthening) (4)

Chemical strengthened glass of this embodiment contains 0.001% to 5% of Se in terms of molar percentage as a coloring component in the glass, wherein the glass has a property configured to provide an absolute value of Δa*n with 1.8 or less, the absolute value of Δa*n being a difference Δa*n between a value of chromaticity a* of reflected light by a D65 light source and a value of chromaticity a* of reflected light by an F2 light source, in a L*a*b* color system, the difference being expressed by the following expression (6), and the glass has a surface compressive stress layer with 5 μm to 70 μm in a depth direction from a surface.

Δa*n=a*value(D65 light source)−a*value(F2 light source) (6)

The chemical strengthened glass of this embodiment contains 0.05% to 5% of Se in terms of molar percentage as a coloring component in the glass, wherein the glass has a property configured to provide an absolute value of Δa*n with 1.8 or less, the absolute value of Δa*n being a difference Δa*n between a value of chromaticity a* of reflected light by a D65 light source and a value of chromaticity a* of reflected light by an F2 light source, in a L*a*b* color system, the difference is expressed by the following expression (6), and the glass has a surface compressive stress layer with 5 μm to 70 μm in a depth direction from a surface.

Δa*n=a*value(D65 light source)−a*value(F2 light source) (6)

Further, the chemical strengthened glass of this embodiment contains 0.001% to 5% of Se in terms of molar percentage as a coloring component in the glass, wherein the glass has a property configured to provide an absolute value of Δa*n with 1.8 or less, the absolute value of Δa*n being a difference Δa*n between a value of chromaticity a* of reflected light by a D65 light source and a value of chromaticity a* of reflected light by an F2 light source, in a L*a*b* color system, the difference being expressed by the following expression (6) and an absolute value of Δb*n with 1.8 or less, the absolute value of Δb*n being a difference Δb*n between a value of chromaticity b* of the reflected light by the D65 light source and a value of chromaticity b* of the reflected light by the F2 light source, in the L*a*b* color system, the difference being expressed by the following expression (7), and the glass has a surface compressive stress layer with 5 μm to 70 μm in a depth direction from a surface.

Δa*n=a*value(D65 light source)−a*value(F2 light source) (6)

Δb*n=b*value(D65 light source)−b*value(F2 light source) (7)

Further, the chemical strengthened glass of this embodiment contains 0.005% to 5% of Se in terms of molar percentage on an oxide basis as a coloring component in the glass, wherein the glass has a property configured to provide an absolute value of Δa*n with 1.8 or less, the absolute value of Δa*n being a difference Δa*n between a value of chromaticity a* of reflected light by a D65 light source and a value of chromaticity a* of reflected light by an F2 light source, in a L*a*b* color system, the difference being expressed by the following expression (6), and an absolute value of Δb*n with 1.8 or less, the absolute value being a difference

Δb*n between a value of chromaticity b* of the reflected light by the D65 light source and a value of chromaticity b* of the reflected light by the F2 light source, in the L*a*b* color system, the difference being expressed by the following expression (7), and the glass has a surface compressive stress layer with 5 μm to 70 μm in a depth direction from a surface.

Δa*n=a*value(D65 light source)−a*value(F2 light source) (6)

Δb*n=b*value(D65 light source)−b*value(F2 light source) (7)

Further, when the chemical strengthened glass of this embodiment, after being chemically strengthened, is cooled in a temperature range from a chemical strengthening temperature to 300° C. at a cooling rate of 30° C./minute or more, the glass has a property configured to provide a color tone variation amount expressed by the following expression (5) with 1.0 or less,

\sqrt{(Δa*i)²+(Δb*i)²} Λ (5),

where Δa*i is a difference between a value of chromaticity a* of reflected light by the F2 light source before the chemical strengthening and a value of chromaticity a* of the reflected light by the F2 light source after the chemical strengthening and the cooling, in the L*a*b* color system, which difference is expressed by the following expression (3), and Δb*i is a difference between a value of chromaticity b* of the reflected light by the F2 light source before the chemical strengthening and a value of chromaticity b* of the reflected light by the F2 light source after the chemical strengthening and the cooling, in the L*a*b* color system, which difference is expressed by the following expression (4).

Δa*i=a*value (before chemical strengthening)−a*value (after chemical strengthening) (3),

Δb*i=b*value (before chemical strengthening)−b*value (after chemical strengthening) (4)

### First Embodiment

Glass for chemical strengthening and chemical strengthened glass of this embodiment (hereinafter, the both are sometimes comprehensively called glass of this embodiment) contain 0.001% to 5% of Se in terms of molar percentage as a coloring component in the glass, which can suppress metamerism. Further, the glass for chemical strengthening and the chemical strengthened glass of this embodiment contain 0.05% to 5% of Se in terms of molar percentage as the coloring component in the glass, which can suppress metamerism. Further, it is possible to reduce a color tone change of the glass before and after chemical strengthening.

The metamerism is an index indicating a degree of a color change of a color tone or an outer color due to color of outside light and can be defined by using the L*a*b* color system standardized by CIE (Commission Internationale de l'Eclairage). The lower the metamerism, the smaller the degree of the color change of the color tone or the outer color due to the color of the outside light. In the glass where the metamerism is high, the color tone of the glass appears greatly different when the kind of a light source is different. For example, the color tone of the glass indoors and the color tone of the glass outdoors greatly differ.

The glass for chemical strengthening of this embodiment contains Se as the coloring component, enabling an absolute value of Δa*m defined by the following expression (1) to be 1.8 or less. Further, the absolute value of Δa*m and an absolute value of Δb*m defined by the following expression (2) can both be 1.8 or less. This makes it possible to reduce a difference between a reflected color tone of the glass indoors and a reflected color tone of the glass outdoors. Δa*m refers to a difference between a value of chromaticity a* of reflected light by a D65 light source and a value of chromaticity a* of reflected light by an F2 light source, in the L*a*b* color system.

Δa*m=a*value(D65 light source)−a*value(F2 light source) (1)

Δb*m refers to a difference between a value of chromaticity b* of the reflected light by the D65 light source and a value of chromaticity b* of the reflected light by the F2 light source, in the L*a*b* color system.

Δb*m=b*value(D65 light source)−b*value(F2 light source) (2)

Incidentally, the glass whose metamerism is suppressed before chemical strengthening also presents the same tendency (the metamerism is suppressed) after the chemical strengthening.

The chemical strengthened glass of this embodiment contains Se as the coloring component, enabling an absolute value of Δa*n defined by the following expression (6) to be 1.8 or less. Further, the absolute value of Δa*n and an absolute value of Δb*n defined by the following expression (7) can both be 1.8 or less. This makes it possible to reduce a difference between a reflected color tone of the glass indoors and a reflected color tone of the glass outdoors. Δa*n refers to a difference between a value of chromaticity a* of reflected light by a D65 light source and a value of chromaticity a* of reflected light by an F2 light source, in the L*a*b* color system.

Δa*n=a*value(D65 light source)−a*value(F2 light source) (6)

Δb*n refers to a difference between a value of chromaticity b* of the reflected light by the D65 light source and a value of chromaticity b* of the reflected light by the F2 light source, in the L*a*b* color system.

Δb*n=b*value(D65 light source)−b*value(F2 light source) (7)

In the L*a*b* color system, the a* value represents a color tone change from red to green and the b* value represents a color tone change from yellow to blue. A color tone change that a person more sensitively senses is the color tone change from red to green. Therefore, according to the glass for chemical strengthening of this embodiment, by making the absolute value of Δa*m 1.8 or less, it is possible to obtain glass whose metamerism is suppressed. Further, the absolute values of Δa*m and Δb*m are both 1.8 or less, which makes it possible to obtain glass whose metamerism is further suppressed. Further, according to the chemical strengthened glass of this embodiment, the absolute value of Δa*n is 1.8 or less, which makes it possible to obtain glass whose metamerism is suppressed. Further, the absolute values of Δa*n and Δb*n are both 1.8 or less, which makes it possible to obtain glass whose metamerism is further suppressed.

When the content of Se, if it is contained, is less than 0.001%, a significant effect of suppressing the metamerism may not be obtained. Preferably, its content is 0.002% or more and typically 0.003% or more. When the Se content is over 5%, the glass becomes unstable, and devitrification is liable to occur. The Se content is preferably 3% or less, and typically 2% or less. Further, Fe₂O₃, similarly to Se, when contained in the glass, has an effect of reducing the metamerism. A Fe₂O₃ content producing a significant effect against the metamerism is preferably 0.01% to 5%, and typically 0.5% to 3%.

In order to reduce the metamerism in the glass for chemical strengthening, the absolute value of Δa*m is preferably 1.5 or less, more preferably 1.3 or less, and still more preferably 1.0 or less. Further, the absolute values of Δa*m and Δb*m are both preferably 1.5 or less, more preferably 1.3 or less, and still more preferably 1.0 or less. Further, in order to reduce the metamerism in the chemical strengthened glass, the absolute value of Δa*n is preferably 1.5 or less, more preferably 1.3 or less, and still more preferably 1.0 or less. Further, the absolute values of Δa*n and Δb*n are both preferably 1.5 or less, more preferably 1.3 or less, and still more preferably 1.0 or less.

The color tone change of the glass before and after the chemical strengthening refers to a color tone variation amount defined as follows. The glass for chemical strengthening, after being chemically strengthened, is cooled in a temperature range from a chemical strengthening temperature to 300° C. at a cooling rate of 30° C./minute or more. Then, a numerical value given by the following expression (5) is referred to as the color tone variation amount,

\sqrt{(Δa*i)²+(Δb*i)²} Λ (5)

where Δa*i is a difference between a value of chromaticity a* of reflected light (F2 light source) before the chemical strengthening and a value of chromaticity a* of the reflected light after the chemical strengthening and the cooling, in the L*a*b* color system, which difference is expressed by the following expression (3), and Δb*i is a difference between a value of chromaticity b* of the reflected light (F2 light source) before the chemical strengthening and a value of chromaticity b* of the reflected light after the chemical strengthening and the cooling, in the L*a*b* color system, which difference is expressed by the following expression (4).

Δa*i=a*value (before chemical strengthening)−a*value (after chemical strengthening) (3)

Δb*i=b*value (before chemical strengthening)−b*value (after chemical strengthening) (4)

The glass of this embodiment contains Se as the coloring component, enabling the color tone variation amount defined by the above expression (5) to be 1.0 or less. This makes it possible to reduce a difference in a reflected color tone of the glass before and after the chemical strengthening. The color tone variation amount is preferably 0.8 or less.

Coloring components contained in glass are typically components called transition metal elements. These transition metal elements have plural valence. Therefore, when the transition metal elements are contained in the glass, those with different in valence exist, and they coexist while maintaining balance among them. Further, some of these transition metal elements have a plural coordination number. Therefore, when the transition metal elements are contained in the glass, those different in coordination number exist, as is the case with the valence, and they coexist while maintaining balance among them. The color tone of the glass differs depending on how the transition metal elements exist in the glass, namely, the aforesaid balance of the valence and the balance of the coordination number. When Se which is not a transition metal element is contained as the coloring component in the glass, a change in the valence number and the coordination number of the coloring component is difficult to occur at least in a temperature range of the chemical strengthening temperature or lower (typically 500° C. or lower), which is thought to be why the color tone change of the glass before and after the chemical strengthening can be suppressed.

The chemical strengthening temperature refers to a treatment temperature of molten salt (chemical strengthening solution) at the time of the chemical strengthening of the glass. Normally, in the chemical strengthening of glass, the glass is immersed in the molten salt while the molten salt is heated to about 400° C. to about 550° C., and the glass is kept in this state for a predetermined time. By doing so, alkali metal ions existing on a surface of the glass (typically, Li ions, Na ions) are exchanged with alkali metal ions having a larger ion radius than that of the alkali metal ions in the molten salt (typically, Na ions or K ions for the Li ions, and K ions for the Na ions). After the glass is kept in this state for the predetermined time, the glass whose chemical strengthening is finished is taken out of the molten salt and cooled to room temperature. A cooling rate in a temperature range down to 300° C. after the glass is taken out of the molten salt is controlled at 30° C./minute or more, which makes it possible to suppress the alleviation of a surface compressive stress of the glass formed by the chemical strengthening and to obtain chemical strengthened glass having high mechanical strength.

Further, in the glass of this embodiment, relative values of absorption coefficients (an absorption coefficient at a 450 nm wavelength/an absorption coefficient at a 600 wavelength and an absorption coefficient at a 550 nm wavelength/an absorption coefficient at a 600 nm wavelength) are both preferably within a range of 0.6 to 1.2. For example, when glass presenting a gray color tone is obtained, the glass sometimes becomes brownish or bluish depending on the coloring component contained in the glass. In order for the glass to express a desired gray color tone that does not appear to be another color, glass with a small variation in the absorption coefficient at light wavelengths in the visible range, that is, glass absorbing the lights in the visible range on average, is preferable. Therefore, a range of the relative values of the absorption coefficients is preferably the range of 0.6 to 1.2. When this range is less than 0.6, the glass is liable to have a bluish black color. On the other hand, when this range is over 1.2, the glass is liable to have a brownish or greenish black color. Incidentally, when the relative values of the absorption coefficient at the 450 nm wavelength/the absorption coefficient at the 600 nm wavelength and the absorption coefficient at the 550 nm wavelength/the absorption coefficient at the 600 nm wavelength both fall within the aforesaid range, it means that the glass having the gray color tone that does not appear to be another color is obtained.

A method of calculating the absorption coefficient of the glass in this embodiment is as follows. Both surfaces of a glass plate are mirror-polished and its thickness t is measured. A spectral transmittance T of this glass plate is measured (for example, an ultraviolet-visible-near infrared spectrophotometer V-570 manufactured by JASCO Corporation is used). Then, the absorption coefficient β is calculated by using a relational expression of T=10^{-β6}.

Further, in the glass of this embodiment, a value of lightness L* defined by using the L*a*b* color system preferably is within a range of 20 to 80. Specifically, when the L* value is within the above range, lightness of the glass is in an intermediate range of “bright” to “dark”, which is a range where a color tone change is easily recognized, and therefore, the use of the glass of this embodiment is more effective. Incidentally, when the L* value is less than 20, the glass presents a deep color, which makes it difficult to recognize the color tone change of the glass. Further, when the L* value is 80 or more, the glass presents a light color, which makes it difficult to recognize the color tone change of the glass. The L* value is preferably 20 to 75, more preferably 20 to 60, and still more preferably 22 to 50. Further, the L* value may be 23 to 40. The value of the lightness L* in this embodiment is based on data obtained from the measurement of reflected light when an F2 light source is used and a white resin plate is installed on a rear surface of the glass.

In the glass for chemical strengthening of this embodiment, when an indentation is formed by using a Vickers indenter on a mirror-finished surface of a glass plate having a 1 mm thickness formed of the glass for chemical strengthening, an indentation load of the Vickers indenter with which a crack occurrence rate becomes 50% is preferably 150 gf or more, more preferably 200 gf or more, and still more preferably 300 gf or more. When the indentation load of the Vickers indenter is less than 150 gf, a scratch is likely to be formed during a manufacturing process before the chemical strengthening and during transportation, and desired strength is not sometimes obtained even if the chemical strengthening is applied. Note that the method of chemically strengthening the glass is not particularly limited. Typically, a method to be described later can be employed.

The chemical strengthening can be done in such a manner that, for example, the glass is immersed in molten salt at 400° C. to 550° C. for about one to about twenty hours. The molten salt used in the chemical strengthening is not particularly limited, provided that it contains potassium ions or sodium ions, but, for example, molten salt of potassium nitrate (KNO₃) is suitably used. Besides, molten salt of sodium nitrate (NaNO₃) or molten salt in which potassium nitrate (KNO₃) and sodium nitrate (NaNO₃) are mixed may be used.

The chemical strengthened glass of this embodiment has a surface compressive stress layer formed on its surface. The chemical strengthening is preferably applied so that a depth (DOL) of the surface compressive stress layer formed on the surface of the glass becomes 5 μm or more, 10 μm or more, 20 μm or more, or 30 μm or more. When the chemical strengthened glass is used for an exterior member, the surface of the glass highly possibly suffers a contact scratch and mechanical strength of the glass sometimes lowers. Therefore, increasing the DOL makes the glass less likely to crack even if the surface of the chemical strengthened glass suffers a scratch. On the other hand, in order to make the glass easily cut after the chemical strengthening, DOL is preferably 70 μm or less.

The chemical strengthened glass of this embodiment has been preferably chemical strengthened so that a surface compressive stress (CS) formed on the surface of the glass becomes 300 MP or more, 500 MPa or more, 700 MPa or more, or 900 MPa or more. Increasing CS results in an increase in mechanical strength of the chemical strengthened glass. On the other hand, too high CS is liable to extremely increase a central tension stress, and therefore, CS is preferably 1200 MPa or less.

The chemical strengthened glass of this embodiment refers to glass in which the surface compressive stress layer with a 5 μm to 70 μm is formed in the depth direction from the surface by the aforesaid chemical strengthening to the glass.

Next, a glass composition of the glass of this embodiment will be described. An example of a first glass composition of this embodiment is one containing, in terms of molar percentage on the following oxide basis, 55% to 80% of SiO₂, 0.5% to 16% of Al₂O₃, 0% to 12% of B₂O₃, 5% to 20% of Na₂O, 0% to 8% of K₂O, 0% to 15% of MgO, 0% to 15% of CaO, 0% to 18% of ΣRO (R represents Mg, Ca, Sr, Ba, and Zn), 0.001% to 5% of Se, 0.01% to 5% of Fe₂O₃, and 0% to 1% of Co₃O₄.

Hereinafter, the composition of the glass of this embodiment will be described by using the content in terms of molar percentage, unless otherwise noted.

SiO₂ is a network former component of the glass and is essential. When its content is less than 55%, stability as the glass lowers or weather resistance lowers. Preferably, its content is 60% or more. More preferably, its content is 65% or more. When the content of SiO₂ is over 80%, viscosity of the glass increases and a melting property greatly deteriorates. Its content is preferably 75% or less, and typically 70% or less.

Al₂O₃ is a component to improve the weather resistance and chemical strengthening ability of the glass and is essential. When its content is less than 0.5%, the weather resistance lowers. Preferably, its content is 1% or more, and typically 3% or more. When the content of Al₂O₃ is over 16%, the viscosity of the glass increases, which makes uniform melting difficult. Preferably, its content is 14% or less, and typically 12% or less. When high CS is formed on the surface of the glass by the chemical strengthening, the content of Al₂O₃ is preferably 5% to 15% (exclusive of 5%). Further, in order for the glass to have an increasedmeltingproperty and to be manufactured at low cost, the content of Al₂O₃ is preferably 0% to 5%.

B₂O₃ is a component to improve the weather resistance of the glass, and can be contained as required, though not essential. When the content of B₂O₃, if it is contained, is less than 4%, a significant effect of improving the weather resistance may not be obtained. Preferably, its content is 5% or more, and typically 6% or more. When the content of B₂O₃ is over 12%, striae occur due to volatilization, which is liable to lower yields. Preferably, its content is 11% or less, and typically 10% or less.

Na₂O is a component to improve the melting property of the glass and is essential since it causes the surface compressive stress layer to be formed by ion exchange. When its content is less than 5%, the melting property becomes poor, and it is difficult to form a desired surface compressive stress layer by the ion exchange. Preferably its content is 7% or more, and typically 8% or more. When the content of Na₂O is over 20%, the weather resistance lowers. Preferably its content is 18% or less, and typically 16% or less.

K₂O is not only a component to improve the melting property of the glass but also works to increase an ion exchange rate in the chemical strengthening, and thus is a component preferably contained, though not essential. When the content of K₂O, if it is contained, is less than 0.01%, a significant effect of improving the melting property may not be obtained, or a significant effect of improving the ion exchange rate may not be obtained. Typically its content is 0.3% or more. When the content of K₂O is over 8%, the weather resistance lowers. Preferably its content is 6% or less, and typically 5% or less.

RO (R represents Mg, Ca, Sr, Ba, and Zn) is a component to improve the melting property of the glass, and at least one kind or more of them can be contained as required, though it is not essential. In this case, when the total content ΣRO (ΣRO represents MgO+CaO+SrO+BaO+ZnO) of RO is less than 1%, the melting property is liable to lower. Preferably it is 3% or more, and typically 5% or more. When ΣRO is over 18%, the weather resistance lowers. Preferably it is 15% or less, more preferably 13% or less, and typically 11% or less.

MgO is a component to improve the melting property of the glass and can be contained as required, though not essential. When the content of MgO, if it is contained, is less than 3%, a significant effect of improving the melting property may not be obtained. Typically its content is 4% or more. When the content of MgO is over 15%, the weather resistance lowers. Preferably its content is 13% or less, and typically 12% or less.

CaO is a component to improve the melting property of the glass and can be contained as required, though not essential. When the content of CaO, if it is contained, is less than 0.01%, a significant effect of improving the melting property cannot be obtained. Typically, its content is 0.1% or more. When the content of CaO is over 15%, the chemical strengthened ability lowers. Preferably, its content is 12% or less, and typically 10% or less. Further, in order to increase the chemical strengthened ability of the glass, it is preferable that CaO is not substantially contained. When high CS is formed on the surface of the glass by the chemical strengthening, the content of CaO is preferably 0% to 5% (exclusive of 5%). Further, in order for the glass to have an increased melting property and to be manufactured at low cost, the content of CaO is preferably 5% to 15%.

SrO is a component to improve the melting property and can be contained as required, though not essential. When the content of SrO, if it is contained, is less than 1%, a significant effect of improving the melting property may not be obtained. Preferably its content is 3% or more, and typically 6% or more. When the content of SrO is over 15%, the weather resistance and the chemical strengthened ability are liable to lower. Preferably its content is 12% or less, and typically 9% or less.

BaO is a component to improve the melting property and can be contained as required, though not essential. When the content of BaO, if it is contained, is less than 1%, a significant effect of improving the melting property may not obtained. Preferably its content is 3% or more, and typically 6% or more. When the content of BaO is over 15%, the weather resistance and the chemical strengthened ability are liable to lower. Preferably its content is 12% or less, and typically 9% or less.

ZnO is a component to improve the melting property and can be contained as required, though not essential. When the content of ZnO, if it is contained, is less than 1%, a significant effect of improving the melting property may not obtained. Preferably its content is 3% or more, and typically 6% or more. When the content of ZnO is over 15%, the weather resistance is liable to lower. Preferably its content is 12% or less, and typically 9% or less.

ZrO₂ is a component to increase the ion exchange rate and may be contained within a range of less than 1%, though not essential. When the content of ZrO₂ is over 1%, themeltingproperty deteriorates and a case where it remains in the glass as an unmelted substance may occur. Typically, ZrO₂ is not contained.

Se is an essential component for coloring the glass. When the content of Se is less than 0.001%, glass witha desiredgray-based color tone is not obtained. Preferably, its content is 0.002% or more, and more preferably 0.003% or more. When the content of Se is over 5%, the color tone of the glass becomes excessively dark, and the desired gray-based color tone is not obtained. Further, the glass becomes unstable, causing devitrification. Preferably its content is 3% or less, and more preferably 2% or less. Further, as described above, the use of Se as the coloring component in the glass makes it possible to suppress the metamerism and reduce the color tone change of the glass before and after the chemical strengthening.

Fe₂O₃ is an essential component for imparting a deep color to the glass. When the total iron content expressed in terms of Fe₂O₃ is less than 0.01%, glass having a desired gray-based color tone cannot be obtained. Preferably its content is 0.02% or more, and more preferably 0.03% or more. When the content of Fe₂O₃ is over 5%, the color tone of the glass becomes excessively dark, and the desired gray-based color tone cannot be obtained, or the glass becomes unstable, causing the devitrification. Preferably its content is 4% or less, and more preferably 3% or less.

Among all the irons, a ratio of the Fe₂O₃-equivalent content of bivalent iron (iron redox) is preferably 10% to 50%, in particular, 15% to 40%. 20% to 30% is the most preferable. When the iron redox is lower than 10%, the decomposition of SO₃, if it is contained, does not progress, and an expected refining effect may not be obtained. When the iron redox is higher than 50%, the decomposition of SO₃ progresses too much before the clarification, and an expected refining effect may not be obtained, or it becomes a source generating bubbles, so that the number of bubbles is liable to increase.

In this specification, the Fe₂O₃-equivalent content of all the irons is described as the content of Fe₂O₃. As for the iron redox, a ratio of bivalent iron converted to Fe₂O₃ in all the irons converted to Fe₂O₃ by Mossbauer spectroscopy can be shown in terms of %. Concretely, evaluation is made by a transmission optical system in which a radiation source (⁵⁷Co), a glass sample (a glass flat plate with a 3 mm to 7 mm thickness cut from the aforesaid glass block, ground, and mirror-polished), and a detector (45431 manufactured by LND, Inc.) are disposed on a straight line. The radiation source is moved relatively in an axial direction of the optical system to cause an energy change of a γ ray due to a Doppler effect. Then, by using a Mossbauer absorption spectrum obtained at room temperature, ratios of bivalent Fe and trivalent Fe are calculated, and the ratio of the bivalent Fe is defined as the iron redox.

Co₃O₄ is not only a coloring component for imparting a deep color to the glass but also is a component exhibiting a bubble eliminating effect when coexisting with iron, and therefore, may be contained within a range of 1% or less, though not essential. Specifically, O₂ bubbles released when trivalent iron becomes bivalent iron in a high-temperature state are absorbed when cobalt is oxidized, and as a result, the O₂ bubbles are reduced, and the bubble eliminating effect is obtained. Further, Co₃O₄ is a component further increasing the refining action when it coexists with SO₃. Specifically, when sodium sulfate (Na₂SO₄) is used as a refining agent, the progress of the reaction of SO₃→SO₂+½O₂ improves the deaeration from the glass, and therefore, an oxygen partial pressure in the glass is preferably low. By adding cobalt in glass containing iron, the release of oxygen due to the reduction of iron can be suppressed by the oxidation of cobalt, so that the decomposition of SO₃ is promoted. This makes it possible to produce the glass with little bubble defects.

Further, glass containing a relatively large amount of alkali metal for the purpose of the chemical strengthening has increased basicity, so that SO₃ is not easily decomposed, and the refining effect lowers. In chemical strengthened glass whose SO₃ is thus not easily decomposed and which contains iron, cobalt is especially effective for promoting the bubble eliminating effect because it promotes the decomposition of SO₃. In order to make such a refining action exhibited, the content of Co₃O₄ is set to 0.01% or more, preferably 0.02% or more, and typically 0.03% or more. When its content is over 0.2%, the glass becomes unstable, causing the devitrification. Its content is preferably 0.18% or less, and more preferably 0.15% or less.

NiO is a coloring component for imparting a gray color tone to the glass, but NiO, when contained in the glass, is liable to cause the metamerism or increase the color tone change of the glass before and after the chemical strengthening. Therefore, the content of NiO is preferably less than 0.05%, more preferably less than 0.01%, and still more preferably it is not substantially contained. Note that, in this specification, “not substantially contained” means that it is not intentionally added, and does not exclude cases where it is unavoidably mixed from a raw material or the like and it is contained to a degree not influencing intended properties. Besides the aforesaid components, the following components may be introduced into the glass composition.

SO₃ is a component acting as a refining agent and can be contained as required, though not essential. When the content of SO₃, if it is contained, is less than 0.005%, an expected refining action is not obtained. Its content is preferably 0.01% or more, and more preferably 0.02% or more. 0.03% or more is the most preferable. Further, when its content is over 0.5%, it serves as a source generating bubbles contrary to the intention, which is liable to slow down the melt-down of the glass or increase the number of bubbles. Its content is preferably 0.3% or less, and more preferably 0.2% or less. 0.1% or less is the most preferable.

SnO₂ is a component acting as a refining agent, and can be contained as required, though not essential. When the content of SnO₂, if it is contained, is less than 0.005%, an expected refining action cannot be obtained. Its content is preferably 0.01% or more, and more preferably 0.05% or more. Further, when its content is over 1%, it serves as a source generating bubbles contrary to the intention, which is liable to slow down the melt-down of the glass and increase the number of bubbles. Its content is preferably 0.8% or less, and more preferably 0.5% or less. 0.3% or less is the most preferable.

Li₂O is a component to improve the melting property and can be contained as required, though not essential. When the content of Li₂O, if it is contained, is less than 1%, a significant effect of improving the melting property may not be obtained. Its content is preferably 3% or more, and typically 6% or more. When the content of Li₂O is over 15%, the weather resistance is liable to lower. Its content is preferably 10% or less, and typically 5% or less.

As a refining agent when the glass is melted, a chloride or a fluoride may be appropriately contained, besides the aforesaid SO₃ and SnO₂. An example of a second glass composition of this embodiment is one containing, in terms of molar percentage on the following oxide basis, 55% to 80% of SiO₂, 0.5% to 16% of Al₂O₃, 0% to 12% of B₂O₃, 5% to 20% of Na₂O, 0% to 8% of K₂O, 0% to 15% of MgO, 0% to 15% of CaO, 0% to 18% of ΣRO (R is Mg, Ca, Sr, Ba, and Zn), 0% to 1% of ZrO₂, 0.05% to 5% of Se, 0.01% to 5% of Fe₂O₃, and 0% to 1% of Co₃O₄.

The composition of the glass of this embodiment will be hereinafter described by using the content in terms of molar percentage unless otherwise noted.

SiO₂ is a network former component of the glass and is essential. When its content is less than 55%, stability as the glass lowers, or the weather resistance lowers. Preferably, its content is 60% or more. More preferably, its content is 65% or more. When the content of SiO₂ is over 80%, the viscosity of the glass increases and the melting property greatly deteriorates. Preferably, its content is 75% or less, and typically 70% or less.

Al₂O₃ is a component to improve the weather resistance and the chemical strengthened ability of the glass and is essential. When its content is less than 0.5%, the weather resistance lowers. Its content is preferably 1% or more, and typically 3% or more. When the content of Al₂O₃ is over 16%, the viscosity of the glass becomes high, which makes uniform melting difficult. Its content is preferably 14% or less, and typically 12% or less. When high CS is formed on the surface of the glass by the chemical strengthening, the content of Al₂O₃ is preferably 5% to 15% (exclusive of 5%). Further, in order for the glass to have an increased melting property and to be manufactured at low cost, the content of Al₂O₃ is preferably 0% to 5%.

B₂O₃ is a component to improve the weather resistance of the glass, and it can be contained as required, though not essential. When the content of B₂O₃, if it is contained, is less than 4%, a significant effect of improving the weather resistance may not be obtained. Its content is preferably 5% or more, and typically 6% or more. When the content of B₂O₃ is over 12%, striae occur due to volatilization, which is liable to lower yields. Its content is preferably 11% or less, and typically 10% or less.

Na₂O is a component to improve the melting property of the glass, and causes the surface compressive stress layer to be formed by ion exchange, and therefore is essential. When its content is less than 5%, the melting property worsens, or it is difficult to form a desired surface compressive stress layer by the ion exchange. Its content is preferably 7% or more, and typically 8% or more. When the content of Na₂O is over 20%, the weather resistance lowers. Its content is preferably 18% or less, and typically 16% or less.

K₂O is not only a component to improve the melting property of the glass but also has an action for increasing an ion exchange rate in the chemical strengthening, and therefore, is a component preferably contained, though not essential. When the content of K₂O, if it is contained, is less than 0.01%, a significant effect of improving the melting property may not be obtained or a significant effect of improving the ion exchange rate may not be obtained. Its content is typically 0.3% or more. When the content of K₂O is over 8%, the weather resistance lowers. Its content is preferably 6% or less, and typically 5% or less.

RO (R represents Mg, Ca, Sr, Ba, and Zn) is a component to improve the melting property of the glass, and at least one kind or more of them can be contained as required, though it is not essential. In this case, when the total content ΣRO (ΣR represents MgO+CaO+SrO+BaO+ZnO) of RO is less than 1%, the melting property is liable to lower. It is preferably 3% or more, and typically 5% or more. When ΣRO is over 18%, the weather resistance lowers. ΣRO is preferably 15% or less, more preferably 13% or less, and typically 11% or less.

MgO is a component to improve the melting property of the glass, and can be contained as required, though not essential. When the content of MgO, if it is contained, is less than 3%, a significant effect of improving the melting property may not be obtained. Its content is typically 4% or more. When the content of MgO is over 15%, the weather resistance lowers. Its content is preferably 13% or less, and typically 12% or less.

CaO is a component to improve the melting property of the glass, and can be contained as required, though not essential. When the content of CaO, if it is contained, is less than 0.01%, a significant effect of improving the melting property cannot be obtained. Its content is typically 0.1% or more. When the content of CaO is over 15%, the chemical strengthened ability lowers. Its content is preferably 12% or less, and typically 10% or less. Further, in order to increase the chemical strengthened ability of the glass, it is preferable that CaO is not substantially contained. When high CS is formed on the surface of the glass by the chemical strengthening, the content of CaO is preferably 0% to 5% (exclusive of 5%). Further, in order for the glass to have an increased melting property and to be manufactured at low cost, the content of CaO is preferably 5% to 15%.

SrO is a component to improve the melting property, and can be contained as required, though not essential. When the content of SrO, if it is contained, is less than 1%, a significant effect of improving the melting property may not be obtained. Its content is preferably 3% or more, and typically 6% or more. When the content of SrO is over 15%, the weather resistance and the chemical strengthened ability are liable to lower. Its content is preferably 12% or less, and typically 9% or less.

BaO is a component to improve the melting property, and can be contained as required, though not essential. When the content of BaO, if it is contained, is less than 1%, a significant effect of improving the melting property may not be obtained. Its content is preferably 3% or more, and typically 6% or more. When the content of BaO is over 15%, the weather resistance and the chemical strengthened ability are liable to lower. Its content is preferably 12% or less, and typically 9% or less.

ZnO is a component to improve the melting property, and can be contained as required, though not essential. When the content of ZnO, if it is contained, is less than 1%, a significant effect of improving the melting property may not be obtained. Its content is preferably 3% or more, and typically 6% or more. When the content of ZnO is over 15%, the weather resistance is liable to lower. Its content is preferably 12% or less, and typically 9% or less.

ZrO₂ is a component to increase the ion exchange rate, and may be contained within a range of less than 1%, though not essential. When the content of ZrO₂ is over 1%, the melting property worsens and a case where it remains in the glass as an unmelted substance may occur. Typically, ZrO₂ is not contained.

Se is an essential component for coloring the glass. When the content of Se is less than 0.05%, glass with a desired gray-based color tone cannot be obtained. Preferably its content is 0.1% or more, and more preferably 0.15% or more. When the content of Se is over 5%, the color tone of the glass becomes excessively dark and the desired gray-based color tone cannot be obtained. Further, the glass becomes unstable, causing the devitrification. Preferably its content is 3% or less, and more preferably 2% or less. Further, as described above, the use of Se as the coloring component in the glass makes it possible to suppress the metamerism and reduce the color tone change of the glass before and after the chemical strengthening.

Fe₂O₃ is an essential component for imparting a deep color to the glass. When the total content of iron expressed in terms of Fe₂O₃ is less than 0.01%, glass having a desired gray-based color tone cannot be obtained. Its content is preferably 0.02% or more, and more preferably 0.03% or more. When the content of Fe₂O₃ is over 5%, the color tone of the glass becomes too dark, and the desired gray-based color tone cannot be obtained. Further, the glass becomes unstable, causing the devitrification. Its content is preferably 4% or less, and more preferably 3% or less.

Among all the irons, a ratio of the Fe₂O₃-equivalent content of bivalent iron (iron redox) is preferably 10% to 50%, in particular, 15% to 40%. 20% to 30% is the most preferable. When the iron redox is lower than 10%, the decomposition of SO₃, if it is contained, does not progress, and an expected refining effect may not be obtained. When the iron redox is higher than 50%, the decomposition of SO₃ progresses too much before the clarification and an expected refining effect may not be obtained, or it becomes a source generating bubbles and the number of bubbles is liable to increase.

In this specification, the Fe₂O₃-equivalent content of all the irons is described as the content of Fe₂O₃. As for the iron redox, a ratio of bivalent iron converted to Fe₂O₃ in all the irons converted to Fe₂O₃ by Mossbauer spectroscopy can be shown in terms of %. Concretely, evaluation is made by a transmission optical system in which a radiation source (⁵⁷Co), a glass sample (a glass flat plate with a 3 nun to 7 mm thickness cut from the aforesaid glass block, ground, and mirror-polished), and a detector (45431 manufactured by LND, Inc.) are disposed on a straight line. The radiation source is moved relatively in an axial direction of the optical system to cause an energy change of a γ ray due to a Doppler effect. Then, by using a Mossbauer absorption spectrum obtained at room temperature, ratios of bivalent Fe and trivalent Fe are calculated, and the ratio of the bivalent Fe is defined as the iron redox.

Co₃O₄ is not only a coloring component for imparting a deep color to the glass but also is a component exhibiting a bubble eliminating effect when coexisting with iron, and therefore, may be contained within a range of 1% or less, though not essential. Specifically, O₂ bubbles released when trivalent iron becomes bivalent iron in a high-temperature state are absorbed when cobalt is oxidized, and as a result, the O₂ bubbles are reduced, and the bubble eliminating effect is obtained. Further, Co₃O₄ is a component further increasing a refining action when it coexists with SO₃. Specifically, when sodium sulfate (Na₂SO₄) is used as a refining agent, the progress of the reaction of SO₃→SO₂+½O₂ improves the deaeration from the glass, and therefore, an oxygen partial pressure in the glass is preferably low. By adding cobalt in glass containing iron, the release of oxygen due to the reduction of iron is suppressed by the oxidation of cobalt, so that the decomposition of SO₃ is promoted. This makes it possible to produce the glass with little bubble defects.

Further, glass containing a relatively large amount of alkali metal for the purpose of the chemical strengthening has increased basicity, so that SO₃ is not easily decomposed, and the refining effect lowers. In chemical strengthened glass whose SO₃ is not thus easily decomposed and which contains iron, cobalt is especially effective for promoting the bubble eliminating effect because it promotes the decomposition of SO₃. In order to make such a refining action exhibited, the content of Co₃O₄ is set to 0.01% or more, preferably 0.02% or more, and typically 0.03% or more. When its content is over 0.2%, the glass becomes unstable, causing the devitrification. Its content is preferably 0.18% or less, and more preferably 0.15% or less.

NiO is a coloring component for imparting a gray color tone to the glass, but NiO, when contained in the glass, is liable to cause the metamerism and increase the color tone change of the glass before and after the chemical strengthening. Therefore, the content of NiO is preferably less than 0.05%, more preferably less than 0.01%, and still more preferably it is not substantially contained. Note that, in this specification, “not substantially contained” means that it is not intentionally added and does not exclude cases where it is unavoidably mixed from a raw material or the like and it is contained to a degree not influencing intended properties. Besides the aforesaid components, the following components may be introduced into the glass composition.

SO₃ is a component acting as a refining agent and can be contained as required, though not essential. When the content of SO₃, if it is contained, is less than 0.005%, an expected refining action is not obtained. Its content is preferably 0.01% or more, and more preferably 0.02% or more. 0.03% or more is the most preferable. Further, when its content is over 0.5%, it serves as a source generating bubbles contrary to the intention, which is liable to slow down the melt-down of the glass or increase the number of bubbles. Its content is preferably 0.3% or less, and more preferably 0.2% or less. 0.1% or less is the most preferable.

SnO₂ is a component acting as a refining agent, and can be contained as required, though not essential. When the content of SnO₂, if it is contained, is less than 0.005%, an expected refining action cannot be obtained. Its content is preferably 0.01% or more, and more preferably 0.05% or more. Further, when its content is over 1%, it serves as a source generating bubbles contrary to the intention, which is liable to slow down the melt-down of the glass and increase the number of bubbles. Its content is preferably 0.8% or less, and more preferably 0.5% or less. 0.3% or less is the most preferable.

Li₂O is a component to improve the melting property and can be contained as required, though not essential. When the content of Li₂O, if it is contained, is less than 1%, a significant effect of improving the melting property may not be obtained. Its content is preferably 3% or more, and typically 6% or more. When the content of Li₂O is over 15%, the weather resistance is liable to lower. Its content is preferably 10% or less, and typically 5% or less.

As a refining agent when the glass is melted, a chloride or a fluoride may be appropriately contained, besides the aforesaid SO₃ and SnO₂.

A method of manufacturing the glass of this embodiment is not particularly limited, but for example, appropriate amounts of various raw materials are compounded, and after the resultant is melted by being heated, it is made uniform by deaeration, agitation, or the like, is molded into a plate shape or the like by a known down-draw method, pressing method, or the like, or is molded into a desired shape by casting. Then, after gradual cooling, it is cut to a desired size, and is subjected to polishing as required. Alternatively, after glass once molded into a nugget shape is heated again to be softened, the glass is press-molded, whereby glass for chemical strengthening having a desired shape is obtained. The glass for chemical strengthening thus obtained is chemically strengthened. Then, the glass having undergone the chemical strengthening is cooled, whereby chemical strengthened glass is obtained.

The glass of this embodiment can have increased glass strength owing to the chemical strengthening. Further, since the metamerism is suppressed and there occurs only a little color tone change of the glass before and after the chemical strengthening, it is possible to easily obtain glass having a desired color tone. Therefore, it can be suitably used in the application requiring glass having high strength and excellent in scratch resistance and design, for example, used for an exterior member of a communication device and an information device of a portable type.

In the foregoing, the glass of this embodiment is described based on the examples, but the structure can be appropriately changed as required within a range not departing from the spirit of this embodiment.

### EXAMPLES

Hereinafter, this embodiment will be described in detail based on examples of the present invention, but this embodiment is not limited only to these examples of the present invention.

In examples 1 to 22 (examples 1 to 20 and example 22 are examples of the present invention and an example 21 is a comparative example) in Table 1 and Table 2, generally used glass raw materials such as an oxide, a hydroxide, a carbonate, and a nitrate were appropriately selected so that compositions became those shown in the tables in terms of molar percentage, and they were measured so that an amount as the glass became 100 ml. Note that SO₃ written in the tables is residual SO₃ which is left in the glasses after sodium sulfate (Na₂SO₄) is added to the glass raw materials and is decomposed, and its calculation values are shown. Further, the compositions shown in Table 1 and Table 2 in terms of molar percentage represent composition ratios of respective components converted to the oxides written in the tables when the aforesaid glass raw materials are used. Therefore, in Table 1 and Table 2, the compositions shown in terms of molar percentage represent preparatory compositions each being one at a pre-stage before the glass raw materials are melted.

Next, each mixture of these raw materials was put into a platinum crucible, which was put into a resistance-heating electric furnace at 1500° C. to 1600° C., and after the raw materials were melted down by being heated for about 0.5 hours, the mixture was melted for one hour and deaerated. Thereafter, it was poured into a mold with about 50 mm length×about 100 mm width×about 20 mm height pre-heated to about 600° C., and was gradually cooled at an about 1° C./minute rate, whereby a glass block was obtained. This glass block was cut, whereby glass with a 40 mm×40 mm size and a 0.8 mm thickness was cut out, and it was thereafter ground, and both surfaces thereof were finally polished to mirror surfaces, whereby plate-shaped glass was obtained.

Regarding the obtained plate-shaped glass for chemical strengthening, a color tone before the chemical strengthening was measured. Further, the following chemical strengthening was performed, followed by cooling. Then, the cooled glass was washed, whereby chemical strengthened glass was obtained. Regarding the obtained chemical strengthened glass, a color tone was measured and a color tone variation amount before and after the chemical strengthening was confirmed. In the chemical strengthening, the glass was chemically strengthened by being immersed in 450° C. molten salt including KNO₃ (99%) and NaNO₃ (1%) for six hours. Further, after the chemical strengthening, the glass was cooled under a cooling condition that the temperature of the glass decreases from 450° C. to 300° C. at 400° C./minute.

As for the color tone of each glass, chromaticity of reflected light in the L*a*b* color system standardized by CIE was measured. In measuring the color tones before the chemical strengthening and after the chemical strengthening, chromaticities of the reflected lights were measured respectively by using a F2 light source and a D65 light source. Further, in confirming the color tone variation amount before and after the chemical strengthening, color tone changes (Δa*i and Δb*i) before and after the chemical strengthening were measured by using the F2 light source, from which the color tone variation amount {square root over (Δa*i)²+(Δb*i)²)} was calculated. For the measurement of the chromaticity of the reflected light in the L*a*b* color system, a spectro-colorimeter (Colori7 manufactured by X-Rite, Inc.) was used. Incidentally, in the measurement, a white resin plate was placed on a rear surface side of the glass (rear surface of a surface irradiated with light from the light source).

Regarding each of the glasses (the example 7, the example 14, the example 17 to the example 21) having undergone the chemical strengthening, a surface compressive stress (CS) and a depth of a surface compressive stress layer (DOL) were measured by using a surface stress measuring apparatus. The surface stress measuring apparatus is an apparatus using the fact that the surface compressive stress layer formed on the surface of the glass exhibits an optical waveguide effect due to a difference of its refractive index from that of the other glass portion where the surface compressive stress layer is not present. Further, as a light source of the surface stress measuring apparatus, LED whose center wavelength was 795 nm was used.

Regarding each of the glasses (the example 7, the example 14, the example 15) before the chemical strengthening, a CIL (Crack Initiation Load) value was measured. The CIL value was found by the following method. Plate-shaped glasses with a 1 mm thickness whose both surfaces were mirror-polished were prepared. By using a Vickers hardness testing machine, a Vickers indenter was pushed in for fifteen seconds and thereafter was removed, and the vicinity of an indentation was observed fifteen seconds later. In the observation, it was examined how many cracks were generated from a corner of the indentation. The measurement was conducted for ten glasses under each of indentation loads 50 gf, 100 gf, 200 gf, 300 gf, 500 gf, and 1 kgf of the Vickers indenter. An average value of the number of the generated cracks was calculated for each load. A relation of the load and the number of the cracks was found by regression calculation by using a sigmoid function. From the result of the regression calculation, the load at which the number of the cracks became two was defined as the CIL value (gf) of the glass.

Evaluation results of the above are shown in Table 1 and Table 2. Note that “-” in the tables indicates that the relevant item was not measured.

TABLE 1

| | | mol % | E1 | E2 | E3 | E4 | E5 | E6 | E7 | E8 | E9 | E10 | E11 |
|---|---|---|---|---|---|---|---|---|---|---|---|---|---|
| | | SiO₂ | 62.7 | 64.04 | 62.79 | 62.73 | 62.73 | 62.79 | 62.85 | 62.66 | 62.79 | 62.71 | 62.74 |
| | | B₂O₃ | 0 | 0 | 0 | 0 | 0 | 0 | 0 | 0 | 0 | 0 | 0 |
| | | Al₂O₃ | 7.8 | 7.97 | 7.81 | 7.8 | 7.8 | 7.81 | 7.82 | 7.8 | 7.81 | 7.8 | 7.81 |
| | | Na₂O | 12.19 | 12.45 | 12.21 | 12.29 | 12.39 | 12.4 | 12.41 | 12.38 | 12.4 | 12.39 | 12.39 |
| | | K₂O | 3.9 | 3.98 | 3.91 | 3.9 | 3.9 | 3.91 | 3.91 | 3.9 | 3.91 | 3.9 | 3.9 |
| | | CaO | 0 | 0 | 0 | 0 | 0 | 0 | 0 | 0 | 0 | 0 | 0 |
| | | MgO | 10.24 | 10.46 | 10.25 | 10.15 | 10.05 | 10.06 | 10.07 | 10.04 | 10.06 | 10.04 | 10.05 |
| | | ZrO₂ | 0.49 | 0.5 | 0.49 | 0.49 | 0.49 | 0.49 | 0.49 | 0.49 | 0.49 | 0.49 | 0.49 |
| | | Fe₂O₃ | 1.86 | 0 | 1.87 | 1.86 | 1.86 | 1.87 | 1.87 | 1.96 | 1.77 | 1.86 | 1.86 |
| | | CuO | 0 | 0 | 0 | 0 | 0 | 0 | 0 | 0 | 0 | 0 | 0 |
| | | NiO | 0 | 0 | 0 | 0 | 0 | 0 | 0 | 0 | 0 | 0 | 0 |
| | | Co₃O₄ | 0.1 | 0 | 0.1 | 0.1 | 0.1 | 0.1 | 0.1 | 0.1 | 0.1 | 0.13 | 0.07 |
| | | Se | 0.49 | 0.5 | 0.49 | 0.49 | 0.49 | 0.39 | 0.29 | 0.49 | 0.49 | 0.49 | 0.49 |
| | | TiO₂ | 0 | 0 | 0 | 0 | 0 | 0 | 0 | 0 | 0 | 0 | 0 |
| | | Cl | 0.2 | 0 | 0 | 0.2 | 0.2 | 0.2 | 0.2 | 0.19 | 0.2 | 0.2 | 0.2 |
| | | SO₃ | 0 | 0.1 | 0.1 | 0 | 0 | 0 | 0 | 0 | 0 | 0 | 0 |
| | | T.A | 99.97 | 100 | 100.02 | 100.01 | 100.01 | 100.02 | 100.01 | 100.01 | 100.02 | 100.01 | 100 |
| Before | F2 | L*value | 25.66 | 94.72 | 25.86 | 25.76 | 25.65 | 25.65 | 25.64 | 25.59 | 25.70 | 25.18 | 26.13 |
| chemical | light | a*value | −0.89 | 0.31 | −0.71 | −0.69 | −0.62 | −0.63 | −0.64 | −0.57 | −0.60 | −0.08 | −0.93 |
| strengthening | source | b*value | −1.31 | −0.50 | −2.77 | −1.38 | −1.21 | −1.16 | −1.75 | −0.73 | −1.53 | −1.55 | −0.97 |
| | D65 | a*value | −0.55 | 0.13 | −0.26 | −0.36 | −0.32 | −0.31 | −0.29 | −0.32 | −0.25 | 0.19 | −0.54 |
| | light | b*value | −1.24 | 0.05 | −2.55 | −1.30 | −1.14 | −1.10 | −1.61 | −0.7 | −1.42 | −1.40 | −0.96 |
| | source | | | | | | | | | | | | |
| | F2 vs | Δa*m | 0.34 | −0.18 | 0.45 | 0.33 | 0.30 | 0.32 | 0.35 | 0.25 | 0.35 | 0.27 | 0.39 |
| | D65 | Δb*m | 0.07 | 0.55 | 0.22 | 0.08 | 0.07 | 0.06 | 0.14 | 0.03 | 0.11 | 0.15 | 0.01 |
| | CIL value (gf) | | — | — | — | — | — | — | 338 | — | — | — | — |
| After | F2 | L*value | — | — | — | — | — | — | 25.94 | — | — | — | — |
| chemical | light | a*value | — | — | — | — | — | — | −0.69 | — | — | — | — |
| strengthening | source | b*value | — | — | — | — | — | — | −2.03 | — | — | — | — |
| | D65 | a*value | — | — | — | — | — | — | −0.3 | — | — | — | — |
| | light | b*value | — | — | — | — | — | — | −1.88 | — | — | — | — |
| | source | | | | | | | | | | | | |
| | F2 vs | Δa*n | — | — | — | — | — | — | 0.39 | — | — | — | — |
| | D65 | Δb*n | — | — | — | — | — | — | 0.15 | — | — | — | — |
| | B/A | Δa*i | — | — | — | — | — | — | 0.39 | — | — | — | — |
| | | Δb*i | — | — | — | — | — | — | 0.15 | — | — | — | — |

| | | | | | | | | | | | |
|---|---|---|---|---|---|---|---|---|---|---|---|
| Color tone | — | — | — | — | — | — | 0.28 | — | — | — | — |
| variation | | | | | | | | | | | |
| amount | | | | | | | | | | | |
| CS (MPa) | — | — | — | — | — | — | 909 | — | — | — | — |
| DOL (μm) | — | — | — | — | — | — | 50.5 | — | — | — | — |

T.A = Total Amount
B/A = Before and after strengthening, under F2 light source
E1 to E11 = Example 1 to Example 11

TABLE 2

| | | mol % | E12 | E13 | E14 | E15 | E16 | E17 | E18 | E19 | E20 | E21 | E22 |
|---|---|---|---|---|---|---|---|---|---|---|---|---|---|
| | | SiO₂ | 62.91 | 62.91 | 62.99 | 67.11 | 62.85 | 70.39 | 70.26 | 70.32 | 70.19 | 63.8 | 71.65 |
| | | B₂O₃ | 0 | 0 | 0 | 0 | 6.78 | 0 | 0 | 0 | 0 | 0 | 0 |
| | | Al₂O₃ | 7.83 | 7.83 | 7.84 | 10.37 | 13.64 | 1.08 | 1.07 | 1.07 | 1.07 | 7.94 | 1.11 |
| | | Na₂O | 12.43 | 12.43 | 12.44 | 11.63 | 13.81 | 12.32 | 12.3 | 12.31 | 12.28 | 12.4 | 12.59 |
| | | K₂O | 3.91 | 3.91 | 3.92 | 2.23 | 0.5 | 0.2 | 0.2 | 0.2 | 0.19 | 3.97 | 0.19 |
| | | CaO | 0 | 0 | 0 | 0.34 | 0.07 | 8.41 | 8.39 | 8.4 | 8.38 | 0 | 8.6 |
| | | MgO | 10.08 | 10.08 | 10.09 | 5.38 | 0.02 | 5.38 | 5.37 | 5.37 | 5.36 | 10.42 | 5.47 |
| | | ZrO₂ | 0.49 | 0.49 | 0.49 | 0 | 0 | 0 | 0 | 0 | 0 | 0.42 | 0 |
| | | Fe₂O₃ | 1.87 | 1.77 | 1.77 | 1.77 | 1.77 | 1.77 | 1.95 | 1.77 | 1.95 | 0 | 0 |
| | | CuO | 0 | 0 | 0 | 0 | 0 | 0 | 0 | 0 | 0 | 0 | 0 |
| | | NiO | 0 | 0 | 0 | 0 | 0 | 0 | 0 | 0 | 0 | 0.651 | 0 |
| | | Co₃O₄ | 0.1 | 0.1 | 0.1 | 0.1 | 0.1 | 0.1 | 0.1 | 0.1 | 0.1 | 0.052 | 0.01 |
| | | Se | 0.2 | 0.29 | 0.27 | 0.27 | 0.27 | 0.27 | 0.27 | 0.27 | 0.27 | 0 | 0.29 |
| | | TiO₂ | 0 | 0 | 0 | 0.6 | 0 | 0 | 0 | 0 | 0 | 0.25 | 0 |
| | | Cl | 0.2 | 0.2 | 0 | 0.2 | 0.2 | 0 | 0 | 0.2 | 0.19 | 0 | 0 |
| | | SO₃ | 0 | 0 | 0.1 | 0 | 0 | 0.1 | 0.1 | 0 | 0 | 0.1 | 0.1 |
| | | T.A | 100.02 | 100.01 | 100.01 | 100 | 100.01 | 100.02 | 100.01 | 100.01 | 99.98 | 100.003 | 100.01 |
| Before | F2 | L*value | 25.97 | 25.92 | 27.59 | 25.96 | 24.74 | 25.68 | 25.7 | 25.44 | 25.38 | 27.16 | 71.67 |
| chemical | light | a*value | −0.83 | −0.76 | −0.69 | −1.06 | −0.05 | 0.66 | 0.5 | 0.19 | 0.02 | 0.06 | −1.58 |
| strengthening | source | b*value | −2.33 | −2.52 | −4.82 | −2.06 | −1.08 | −5.8 | −5.86 | −3.16 | −2.46 | −3.43 | −32.9 |
| | D65 | a*value | −0.42 | −0.29 | −0.13 | −0.72 | −0.10 | 1.33 | 1.16 | 0.58 | 0.29 | 2.00 | −0.12 |
| | light | b*value | −2.19 | −2.27 | −4.36 | −1.92 | −0.92 | −5.23 | −5.29 | −2.84 | −2.19 | −3.70 | −29.63 |
| | source | | | | | | | | | | | | |
| | F2 vs | Δa*m | 0.41 | 0.47 | 0.56 | 0.34 | −0.05 | 0.67 | 0.66 | 0.39 | 0.27 | 1.94 | 1.46 |
| | D65 | Δb*m | 0.14 | 0.25 | 0.46 | 0.14 | 0.16 | 0.57 | 0.57 | 0.32 | 0.27 | −0.27 | 3.27 |
| | CIL value (gf) | | — | — | 249 | 498 | — | — | — | — | — | — | — |
| After | F2 | L*value | — | — | 26.51 | — | — | 25.95 | 26 | 25.71 | 25.64 | 27.02 | — |
| chemical | light | a*value | — | — | −0.88 | — | — | 0.75 | 0.53 | 0.22 | 0.12 | 0.35 | — |
| strengthening | source | b*value | — | — | −3.92 | — | — | −5.94 | −5.36 | −2.93 | −2.17 | −4.45 | — |
| | D65 | a*value | — | — | −0.34 | — | — | 1.46 | 1.13 | 0.63 | 0.44 | 2.34 | — |
| | light | b* value | — | — | −3.59 | — | — | −5.37 | −4.86 | −2.64 | −1.96 | −4.60 | — |
| | source | | | | | | | | | | | | |
| | F2 vs | Δa*n | — | — | 0.54 | — | — | 0.71 | 0.60 | 0.41 | 0.32 | 1.99 | — |
| | D65 | Δb*n | — | — | 0.33 | — | — | 0.57 | 0.50 | 0.29 | 0.21 | −0.15 | — |
| | B/A | Δa*i | — | — | 0.19 | — | — | −0.09 | −0.03 | −0.03 | −0.10 | −0.29 | — |
| | | Δb*i | — | — | −0.90 | — | — | 0.14 | −0.50 | −0.23 | −0.29 | 1.02 | — |

| | | | | | | | | | | | |
|---|---|---|---|---|---|---|---|---|---|---|---|
| Color tone | — | — | 0.92 | — | — | 0.17 | 0.50 | 0.23 | 0.31 | 1.06 | — |
| variation | | | | | | | | | | | |
| amount | | | | | | | | | | | |
| CS (MPa) | — | — | 954 | — | — | 864 | 849 | 896 | 878 | 745 | — |
| DOI (μm) | — | — | 37.6 | — | — | 7.1 | 7.1 | 7.1 | 7.0 | 75 | — |

T.A = Total Amount
B/A = Before and after strengthening, under F2 light source
E12 to E22 = Example 12 to Example 22

As shown in Table 1 and Table 2, in all of the glasses of the examples of the present invention containing Se, Δa*m being an index of the metamerism is 1.8 or less, from which it is seen that the metamerism can be suppressed. Further, in all of the glasses of the examples of the present invention, Δa*m and Δb*m are both 1.8 or less, from which it is seen that the metamerism can be further suppressed. Further, in the glasses of the example 7, the example 14, and the examples 17 to 20, Δa*n and Δb*n are both 1.8 or less, from which it is seen that the metamerism can be suppressed even after the chemical strengthening. On the other hand, in the glass of the comparative example not containing Se, Δa*m is over 1.8, which means that the metamerism cannot be suppressed.

Further, in all of the glasses of the example 7, the example 14, and the examples 17 to 20, the color tone variation amount being an index of the color tone change of the glass before and after the chemical strengthening is 1.0 or less, from which it is seen that the color tone change before and after the chemical strengthening is small. On the other hand, in the glass of the comparative example not containing Se, the color tone variation amount is over 1.0, which means that the color tone change before and after the chemical strengthening is large. It is thought that the color tone change in the glass of the comparative example occurs because of an influence of changes in the valence number and the coordination number of Ni, which is the coloring component in the glass, before and after the chemical strengthening.

From the above evaluation result of the CIL value, it is seen that the glasses of the example 7, the example 14, and the example 15 are high-strength glasses not easily suffering a scratch. Glass not yet chemically strengthened suffers a scratch during its manufacturing process and transportation, and the scratch becomes a starting point of breakage after the chemical strengthening to be a cause to lower the strength of the glass. The CIL value of ordinary soda lime glass is, for example, about 150 gf, while the CIL values of the above glasses are larger than that of the soda lime glass, and it can be inferred that this is why the glass having high strength even after the chemical strengthening can be obtained.

Regarding the glasses of the example 7, the example 14, and the example 21, relative values of absorption coefficients before the chemical strengthening (an absorption coefficient at a 550 nm wavelength/an absorption coefficient at a 600 nm wavelength and an absorption coefficient at a 450 nm wavelength/an absorption coefficient at a 600 nm wavelength) were measured. The measurement results are shown in Table 3.

The absorption coefficients were found by the following method. A thickness t of the plate-shaped glass whose both surfaces were mirror-polished was measured by a caliper. A spectral transmittance T of this glass was measured by using an ultraviolet-visible-near infrared spectrophotometer (V-570 manufactured by JASCO Corporation). Then, the absorption coefficient β was calculated by using a relational expression T=10^{-βt}.

TABLE 3

| | | Example 7 | Example 14 | Example 21 |
|---|---|---|---|---|
| Absorption coefficient | \textcircled{1}600 nm | 1.881 | 1.847 | 1.374 |
| at each wavelength | \textcircled{2}550 nm | 1.277 | 1.305 | 1.122 |
| | \textcircled{3}450 nm | 1.291 | 1.373 | 1.282 |
| Relative value of | \textcircled{3}/\textcircled{1} | 0.69 | 0.74 | 0.93 |
| absorption coefficients | \textcircled{2}/\textcircled{1} | 0.68 | 0.71 | 0.82 |

From the evaluation results of the absorption coefficients, in each of the glasses, the relative values of the absorption coefficients (the absorption coefficient at the 450 nm wavelength/the absorption coefficient at the 600 nm wavelength, the absorption coefficient at the 550 nm wavelength/the absorption coefficient at the 600 nm wavelength) are both within a range of 0.6 to 1.2, from which it is seen that these glasses are glasses absorbing visible-range lights on average. Therefore, it is possible to obtain glass that has a gray color tone not including a specific color shade and different from, for example, a brownish gray and a bluish gray.

Next, analysis values of the examples of the present invention listed in Table 1 and Table 2 are shown in Table 4 and Table 5. The glass for chemical strengthening and the chemical strengthened glass of this embodiment contain Se as the coloring component in the glass. When the glass raw material contains Se, Se volatilizes during a process of melting the glass raw material. Out of Se put in the glass raw material, a ratio of Se remaining in the glass (hereinafter, sometimes referred to as “Se residual ratio”) differs depending on a melting method of the glass raw material. For example, when the glass raw material is melted in a pot furnace, about 80% to about 99% of Se in the raw material sometimes volatilizes during the melting process.

In the example 3, the example 4, the example 14, the example 19, the example 20, and the example 22 shown in Table 4 and Table 5, the glasses were produced by melting the glass raw materials composed of the components listed in Table 1 and Table 2, and the contents of the respective components obtained when the glasses were subjected composition analysis by a wet analysis method are shown. In the example 1, the example 2, the example 5 to the example 13, the example 15, and the example 16 shown in Table 4 and Table 5, only the Se content is a calculation value calculated from an average value of the Se residual ratios of the example 3, the example 4, and the example 14, and the components other than Se are the same as those in Table 1 and Table 2. Further, in the example 17 and the example 18 shown in Table 4 and Table 5, only the Se content is a calculation value calculated from an average value of the Se residual ratios of the example 19, the example 20, and the example 22, and the components other than Se are the same as those in Table 2.

The Se residual ratio, as is expressed by “Se residual ratio=(Se content in analysis value/Se content in preparatory composition)×100 [%]), indicates how much of an addition amount of Se at the time of the preparation remains when actual glass is formed, which is found by comparing the preparatory compositions shown in Table 1 and Table 2 and the analysis values shown in Table 4 and Table 5 of the respective examples of the present invention. The average value of the Se residual ratios in the example 3, the example 4, and the example 14 is 0.65%. Further, the average value of the Se residual ratios of the example 19, the example 20, and the example 22 is 3.88%. In the glasses of the examples of the present invention for which the analysis value of the Se content is not actually measured, a value equal to the Se content written in Table 1 and Table 2 multiplied by the Se residual ratio was written as the calculation value in Table 4 and Table 5. Note that a melting temperature of the glass raw material of the glass differs depending on the components that it contains. Since the Se residual ratio is influenced by the melting temperature of the glass raw material, the Se residual ratio was calculated for two separate groups as described above, considering the melting temperature of the glass raw material of each of the examples of the present invention.

TABLE 4

| mol % | E1 | E2 | E3 | E4 | E5 | E6 | E7 | E8 | E9 | E10 | E11 |
|---|---|---|---|---|---|---|---|---|---|---|---|
| SiO₂ | 62.7 | 64.04 | 62.79 | 62.73 | 62.73 | 62.79 | 62.85 | 62.66 | 62.79 | 62.71 | 62.74 |
| B₂O₃ | 0 | 0 | 0 | 0 | 0 | 0 | 0 | 0 | 0 | 0 | 0 |
| Al₂O₃ | 7.8 | 7.97 | 7.81 | 7.8 | 7.8 | 7.81 | 7.82 | 7.8 | 7.81 | 7.8 | 7.81 |
| Na₂O | 12.19 | 12.45 | 12.21 | 12.29 | 12.39 | 12.4 | 12.41 | 12.38 | 12.4 | 12.39 | 12.39 |
| K₂O | 3.9 | 3.98 | 3.91 | 3.9 | 3.9 | 3.91 | 3.91 | 3.9 | 3.91 | 3.9 | 3.9 |
| CaO | 0 | 0 | 0 | 0 | 0 | 0 | 0 | 0 | 0 | 0 | 0 |
| MgO | 10.24 | 10.46 | 10.25 | 10.15 | 10.05 | 10.06 | 10.07 | 10.04 | 10.06 | 10.04 | 10.05 |
| ZrO₂ | 0.49 | 0.5 | 0.49 | 0.49 | 0.49 | 0.49 | 0.49 | 0.49 | 0.49 | 0.49 | 0.49 |
| Fe₂O₃ | 1.86 | 0 | 1.87 | 1.86 | 1.86 | 1.87 | 1.87 | 1.96 | 1.77 | 1.86 | 1.86 |
| CuO | 0 | 0 | 0 | 0 | 0 | 0 | 0 | 0 | 0 | 0 | 0 |
| NiO | 0 | 0 | 0 | 0 | 0 | 0 | 0 | 0 | 0 | 0 | 0 |
| Co₃O₄ | 0.1 | 0 | 0.1 | 0.1 | 0.1 | 0.1 | 0.1 | 0.1 | 0.1 | 0.13 | 0.07 |
| Se | 0.0032 | 0.0033 | 0.0017 | 0.0033 | 0.0032 | 0.0025 | 0.0019 | 0.0032 | 0.0032 | 0.0032 | 0.0032 |
| TiO₂ | 0 | 0 | 0 | 0 | 0 | 0 | 0 | 0 | 0 | 0 | 0 |
| Cl | 0.2 | 0 | 0 | 0.2 | 0.2 | 0.2 | 0.2 | 0.19 | 0.2 | 0.2 | 0.2 |
| SO₃ | 0 | 0.1 | 0.1 | 0 | 0 | 0 | 0 | 0 | 0 | 0 | 0 |
| T.A | 99.48 | 99.50 | 99.53 | 99.52 | 99.52 | 99.63 | 99.72 | 99.52 | 99.53 | 99.52 | 99.51 |

T.A = Total Amount;
E1 to E11 = Example 1 to Example 11

TABLE 5

| mol % | E12 | E13 | E14 | E15 | E16 | E17 | E18 | E19 | E20 | E21 | E22 |
|---|---|---|---|---|---|---|---|---|---|---|---|
| SiO₂ | 62.91 | 62.91 | 62.99 | 67.11 | 62.85 | 70.39 | 70.26 | 70.32 | 70.19 | 63.8 | 71.65 |
| B₂O₃ | 0 | 0 | 0 | 0 | 6.78 | 0 | 0 | 0 | 0 | 0 | 0 |
| Al₂O₃ | 7.83 | 7.83 | 7.84 | 10.37 | 13.64 | 1.08 | 1.07 | 1.07 | 1.07 | 7.94 | 1.11 |
| Na₂O | 12.43 | 12.43 | 12.44 | 11.63 | 13.81 | 12.32 | 12.3 | 12.31 | 12.28 | 12.4 | 12.59 |
| K₂O | 3.91 | 3.91 | 3.92 | 2.23 | 0.5 | 0.2 | 0.2 | 0.2 | 0.19 | 3.97 | 0.19 |
| CaO | 0 | 0 | 0 | 0.34 | 0.07 | 8.41 | 8.39 | 8.4 | 8.38 | 0 | 8.6 |
| MgO | 10.08 | 10.08 | 10.09 | 5.38 | 0.02 | 5.38 | 5.37 | 5.37 | 5.36 | 10.42 | 5.47 |
| ZrO₂ | 0.49 | 0.49 | 0.49 | 0 | 0 | 0 | 0 | 0 | 0 | 0.42 | 0 |
| Fe₂O₃ | 1.87 | 1.77 | 1.77 | 1.77 | 1.77 | 1.77 | 1.95 | 1.77 | 1.95 | 0 | 0 |
| CuO | 0 | 0 | 0 | 0 | 0 | 0 | 0 | 0 | 0 | 0 | 0 |
| NiO | 0 | 0 | 0 | 0 | 0 | 0 | 0 | 0 | 0 | 0.651 | 0 |
| Co₃O₄ | 0.1 | 0.1 | 0.1 | 0.1 | 0.1 | 0.1 | 0.1 | 0.1 | 0.1 | 0.052 | 0.01 |
| Se | 0.0013 | 0.0019 | 0.0025 | 0.0018 | 0.0018 | 0.010 | 0.010 | 0.013 | 0.014 | 0 | 0.011 |
| TiO₂ | 0 | 0 | 0 | 0.6 | 0 | 0 | 0 | 0 | 0 | 0.25 | 0 |
| Cl | 0.2 | 0.2 | 0 | 0.2 | 0.2 | 0 | 0 | 0.2 | 0.19 | 0 | 0 |
| SO₃ | 0 | 0 | 0.1 | 0 | 0 | 0.1 | 0.1 | 0 | 0 | 0.1 | 0.1 |
| T.A | 99.82 | 99.72 | 99.74 | 99.73 | 99.74 | 99.76 | 99.75 | 99.75 | 99.72 | 100.00 | 99.73 |

T.A = Total Amount;
E12 to E22 = Example 12 to Example 22

According to this embodiment, it is possible to produce colored glass for chemical strengthening and colored chemical strengthened glass having suppressed metamerism, undergoing a small color tone change before and after chemical strengthening, and excellent in mechanical strength.

The glass for chemical strengthening and the chemical strengthened glass of this embodiment are usable for decorations of operation panels of AV devices, OA devices, and the like, opening/closing doors, operation buttons/knobs of these products, or decorative panels and the like disposed around rectangular display surfaces of image display panels of digital photo frames, TV, and the like, and for glass exterior members for electronic devices. Further, they are also usable for vehicle interior members, members of furniture and the like, building materials used outdoors and indoors, and so on.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. Glass for chemical strengthening, comprising 0.001% to 5% of Se in terms of molar percentage as a coloring component in the glass,
wherein the glass has a property configured to provide an absolute value of Δa*m with 1.8 or less, the absolute value of Δa*m being a difference Δa*m between a value of chromaticity a* of reflected light by a D65 light source and a value of chromaticity a* of reflected light by an F2 light source, in a L*a*b* color system, the difference being expressed by the following expression (1),
Δa*m=a*value(D65 light source)−a*value(F2 light source) (1).

2. The glass for chemical strengthening according to claim 1,
wherein the glass contains the Se in an amount of 0.05% to 5% in terms of molar percentage.

3. The glass for chemical strengthening according to claim 1,
wherein the glass has a property configured to provide an absolute value of Δb*m with 1.8 or less, the absolute value of Δb*m being a difference Δb*m between a value of chromaticity b* of the reflected light by the D65 light source and a value of chromaticity b* of the reflected light by the F2 light source, in the L*a*b* color system, the difference being expressed by the following expression (2),
Δb*m=b*value(D65 light source)−b*value(F2 light source) (2).

4. The glass for chemical strengthening according to claim 1,
wherein, when the glass for chemical strengthening, after being chemically strengthened, is cooled in a temperature range from a chemical strengthening temperature to 300° C. at a cooling rate of 30° C./minute or more, the glass has a property configured to provide a color tone variation amount expressed by the following expression (5) with 1.0 or less,
\sqrt{(Δa*i)²+(Δb*i)²} Λ (5)
where Δa*i is a difference between a value of chromaticity a* of reflected light by the F2 light source before the chemical strengthening and a value of chromaticity a* of the reflected light by the F2 light source after the chemical strengthening and the cooling, in the L*a*b* color system, which difference is expressed by the following expression (3),
Δa*i=a*value (before chemical strengthening)−a*value (after chemical strengthening) (3); and
Δb*i is a difference between a value of chromaticity b* of the reflected light by the F2 light source before the chemical strengthening and a value of chromaticity b* of the reflected light by the F2 light source after the chemical strengthening and the cooling, in the L*a*b* color system, which difference is expressed by the following expression (4)
Δb*i=b*value(before chemical strengthening)−b*value(after chemical strengthening) (4).

5. The glass for chemical strengthening according to claim 1,
wherein the glass has a property configured to provide an absorption coefficient at a 550 nm wavelength/an absorption coefficient at a 600 nm wavelength and an absorption coefficient at a 450 nm wavelength/an absorption coefficient at a 600 nm wavelength with both within a range of 0.6 to 1.2.

6. The glass for chemical strengthening according to claim 1,
wherein the glass has a property configured to provide a value of lightness L* of the reflected light by the F2 light source, in the L*a*b* color system, with within a range of 20 to 80.

7. The glass for chemical strengthening according to claim 1,
wherein the glass has a property configured to provide a value of lightness L* of the reflected light by the F2 light source, in the L*a*b* color system, with within a range of 20 to 60.

8. The glass for chemical strengthening according to claim 1,
wherein, when an indentation is formed by using a Vickers indenter on a mirror-finished surface of a glass plate with a 1 mm thickness produced from the glass for chemical strengthening, a load of the Vickers indenter with which a crack occurrence rate becomes 50% is 150 gf or more.

9. The glass for chemical strengthening according to claim 1,
wherein the glass contains, in terms of molar percentage on the following oxide basis, 55% to 80% of SiO₂, 0.5% to 16% of Al₂O₃, 0% to 12% of B₂O₃, 5% to 20% of Na₂O, 0% to 8% of K₂O, 0% to 15% of MgO, 0% to 15% of CaO, 0% to 18% of ΣRO (R represents Mg, Ca, Sr, Ba, and Zn), 0.001% to 5% of Se, 0.01% to 5% of Fe₂O₃, and 0% to 1% of Co₃O₄.

10. The glass for chemical strengthening according to claim 1,
wherein the glass contains, in terms of molar percentage on the following oxide basis, 55% to 80% of SiO₂, 0.5% to 16% of Al₂O₃, 0% to 12% of B₂O₃, 5% to 20% of Na₂O, 0% to 8% of IC₂O, 0% to 15% of MgO, 0% to 15% of CaO, 0% to 18% of ΣRO (R represents Mg, Ca, Sr, Ba, and Zn), 0% to 1% of ZrO₂, 0.05% to 5% of Se, 0.01% to 5% of Fe₂O₃, and 0% to 1% of Co₃O₄.

11. The glass for chemical strengthening according to claim 1,
wherein the glass contains 0% to 0.05% of NiO.

12. Chemical strengthened glass, comprising 0.001% to 5% of Se in terms of molar percentage as a coloring component in the glass,
wherein the glass has a property configured to provide an absolute value of Δa*n with 1.8 or less, the absolute value of Δa*n being a difference Δa*n between a value of chromaticity a* of reflected light by a D65 light source and a value of chromaticity a* of reflected light by an F2 light source, in a L*a*b* color system, the difference being expressed by the following expression (6),
Δa*n=a*valueD65 light source)−a*value(F2 light source) (6), and the glass has a surface compressive stress layer with 5 μm to 70 μm in a depth direction from a surface.

13. The chemical strengthened glass according to claim 12,
wherein the glass contains the Se in an amount of 0.05% to 5% in terms of molar percentage.

14. The chemical strengthened glass according to claim 12,
wherein the glass has a property configured to provide an absolute value of Δb*n with 1.8 or less, the absolute value of Δb*n being a difference Δb*n between a value of chromaticity b* of the reflected light by the D65 light source and a value of chromaticity b* of the reflected light by the F2 light source, in the L*a*b* color system, the difference being expressed by the following expression (7),
Δb*n=b*value(D65 light source)−b*value(F2 light source) (7).

15. The chemical strengthened glass according to claim 12,
wherein, when the chemical strengthened glass, after being chemically strengthened, is cooled in a temperature range from a chemical strengthening temperature to 300° C. at a cooling rate of 30° C./minute or more, the glass has a property configured to provide a color tone variation amount expressed by the following expression (5) with 1.0 or less,
\sqrt{(Δa*i)²+(Δb*i)²} Λ (5)
where Δa*i is a difference between a value of chromaticity a* of reflected light by the F2 light source before the chemical strengthening and a value of chromaticity a* of the reflected light by the F2 light source after the chemical strengthening and the cooling, in the L*a*b* color system, which difference is expressed by the following expression (3),
Δa*i=a*value (before chemical strengthening)−a*value (after chemical strengthening) (3); and
Δb*i is a difference between a value of chromaticity b* of the reflected light by the F2 light source before the chemical strengthening and a value of chromaticity b* of the reflected light by the F2 light source after the chemical strengthening and the cooling, in the L*a*b* color system, which difference is expressed by the following expression (4)
Δb*i=b*value (before chemical strengthening)−b*value (after chemical strengthening) (4)

16. The chemical strengthened glass according to claim 12,
wherein the glass has a property configured to provide an absorption coefficient at a 550 nm wavelength/an absorption coefficient at a 600 nm wavelength and an absorption coefficient at a 450 nm wavelength/an absorption coefficient at a 600 nm wavelength with both within a range of 0.6 to 1.2.

17. The chemical strengthened glass according to claim 12,
wherein the glass has a property configured to provide a value of lightness L* of the reflected light by the F2 light source, in the L*a*b* color system, with within a range of 20 to 80.

18. The chemical strengthened glass according to claim 12,
wherein the glass has a property configured to provide a value of lightness L* of the reflected light by the F2 light source, in the L*a*b* color system, with within a range of 20 to 60.

19. The chemical strengthened glass according to claim 12,
wherein a surface compressive stress of the glass is a range of 300 MPa to 1200 MPa.

20. The chemical strengthened glass according to claim 12,
wherein the glass contains, in terms of molar percentage on the following oxide basis, 55% to 80% of SiO₂, 0.5% to 16% of Al₂O₃, 0% to 12% of B₂O₃, 5% to 20% of Na₂O, 0% to 8% of K₂O, 0% to 15% of MgO, 0% to 15% of CaO, 0% to 18% of ΣRO (R represents Mg, Ca, Sr, Ba, and Zn), 0.001% to 5% of Se, 0.01% to 5% of Fe₂O₃, and 0% to 1% of Co₃O₄.

21. The chemical strengthened glass according to claim 12,
wherein the glass contains, in terms of molar percentage on the following oxide basis, 55% to 80% of SiO₂, 0.5% to 16% of Al₂O₃, 0% to 12% of B₂O₃, 5% to 20% of Na₂O, 0% to 8% of K₂O, 0% to 15% of MgO, 0% to 15% of CaO, 0% to 18% of ΣRO (R represents Mg, Ca, Sr, Ba, and Zn), 0% to 1% of ZrO₂, 0.05% to 5% of Se, 0.01% to 5% of Fe₂O₃, and 0% to 1% of Co₃O₄.

22. The chemical strengthened glass according to claim 12,
wherein the glass contains 0% to 0.05% of NiO.

23. The chemical strengthened glass according to claim 12,
wherein the glass is used as an exterior member.
